(19) United States
(12) Patent Application Publication
(10) Pub. No.: US 2018/0240317 A1
(43) Pub. Date: Aug. 23, 2018

(54) Composite material for signaling local overheating of electrical equipment

(71) Applicant: LIMITED LIABILITY COMPANY "TERMOELEKTRICA", Moscow (RU)

(72) Inventor: Aleksey Valeryevich LESIV, Dolgoprudnyy (RU)

(21) Appl. No.: 15/751,458

(22) PCT Filed: Aug. 10, 2016
(86) PCT No.: PCT/RU16/00530

§ 371 Date: Feb. 8, 2018

(30) Foreign Application Priority Data
Aug. 10, 2015 (RU) 2015133303

(51) Int. Cl. G08B 17/00; C08F 20/56

(52) U.S. Cl. CPC G08B 17/00; C08F 20/56

(57) ABSTRACT

The proposed means are intended to prevent fires arising from local overheating of electrical equipment, e.g. wall outlets. The proposed means include polymer composite materials characterized with a continuous phase consisting of a thermosetting polymer, filled with an odorant such as sulfur dioxide, low-molecular-weight mercaptans, dialkyl sulfides, dialkyl disulfides, or mixtures thereof, having an explosive destruction temperature in the range of 80-200° C. The odorants can be used in pure form, or a solution that can be contained inside microcapsules with a polymeric material shell distributed in the binder. The polymeric material can be represented by a polymer gel formed by crosslinked polymer particles swollen in an odorant solution placed in a polymeric matrix, or by sorbent particles with an odorant occluded thereon placed in a thermosetting polymeric matrix, or by porous polymer particles with closed-type pores or channels filled with an odorant or odorant solution placed in a polymeric matrix.

### CROSS-REFERENCE TO RELATED APPLICATIONS

This application is a U.S. national stage application of a PCT application PCT/RU2016/000530 filed on 10 Aug. 2016, whose disclosure is incorporated herein in its entirety by reference, which PCT application claims priority of a Russian Federation patent application No. RU2015133303 filed on 10 Aug. 2015.

### FIELD OF THE INVENTION

The invention relates to materials suitable for being used as pre-fire situations control for fires resulting from local overheating of electrical equipment and is intended to prevent fires resulting from such malfunctions.

### BACKGROUND OF THE INVENTION

To date, more than 20% of all fires occur due to violations in the operation of the electrical equipment and electrical devices. Most often, ignition occurs in the area of electrical contacts.

As a rule, a fire does not occur spontaneously. It is usually preceded by a prolonged breakdown of the wire at the junction points. At the same time the current intensity does not increase dramatically, as in the case of a short circuit, therefore, electromagnetic releases used in modern circuit breakers cannot be used for protection in such situations.

So, with poor contact in sockets or switchboards there is an increased resistance, and, consequently, a source of increased temperature. The wire is deformed by the action of thermal expansion, and multiple cycles of heating and cooling make its deformation critical. In the place of constriction the wire becomes thinner, its oxidation occurs. As a consequence, the resistance at the junction point keeps on increasing, and as a result, heating increases even more. Ultimately, this can lead to a fire.

To avoid such situations, it is advisable to have a simple method that allows detecting such a defect at an early stage, since eliminating the cause of overheating is much less resource-intensive and labor-consuming than eliminating the consequences of a fire.

The background of the invention knows various pre-fire situations alarms representing functional analogues of the material of the present invention.

Thus, a method is known for diagnostics of a pre-fire situation and preventing a fire, including measuring the intensity of monochromatic radiation emitted by a pulsed source at the frequency of its absorption by thermal destruction products of the identified materials, and generating a control signal for fire alarm when the concentrations of their admissible values are exceeded [1].

The disadvantages of the known method include its low reliability, high probability of false responses, as well as insufficiently early detection of fires, which is caused by the development of a control signal without taking into account the rate of increase in concentration and the assessment of a fire hazard situation with respect to the concentrations of insufficient quantities of controlled gas components.

A method and a device for detecting a pre-fire situation based on the infrared spectroscopy is known. The device comprises an optically coupled source and a radiation receiver coupled to the first amplifier and a processing pattern that includes two radiation receivers, the second and the third amplifier which, together with the first amplifier, are connected to an analog-to-digital converter through the respective blocks of admissible concentrations of fire hazardous components, the output of the converter is connected through the microprocessor and digital-to-analog converter to the alarm unit, while the second output of the microprocessor is connected to the monitor. It is designed to detect the products of thermal decomposition of various organic materials formed under the influence of a non-standard heat source, which can arise, in particular, as a result of sparking or short-circuiting in the electrical commutation equipment. [2].

The disadvantage of the known technical solution is that it reacts to the appearance of gases and smoke accompanying the already started ignition, i.e. it gives a signal after the start of the fire.

A device is known which is being a junction box containing a temperature change sensor connected to the microprocessor control unit [3].

The disadvantage of this device is its relatively high cost, as well as the fact that it does not provide continuous monitoring of any point of the electrical network or electrical unit.

As an alternative method for diagnosing the pre-fire situation, it is proposed to apply a special formulation to the current-conducting part, which, when heated above a certain temperature, emits an odorant—a substance having a specific, warning odor.

Odorants are currently used to give a warning odor to a natural gas and liquefied gases used for industrial purposes. They can detect leaks in gas utility lines and equipment, as well as the presence of gases in industrial and residential areas long before they are accumulated in explosive or toxic concentrations. As odorants, sulfur-containing compounds are usually used: amercaptans (methyl mercaptan, ethyl mercaptan, propyl mercaptan, isopropyl mercaptan, etc.) and sulphides (dimethyl sulfide, diethyl sulfide, dimethyl disulphide, etc.). A more intense and stable odor compared to individual components is a mixture of several odorants.

Since odorants have a very strong smell, they shall be stored hermetically-sealed and released strictly at the time of the wiring overheating. As a system that releases odorants upon heating, a device made of a crosslinked polymeric composite material having an explosive destruction temperature in the range of 80-200° C., including odorants as fillers, can be used.

Structural analogues of the invention material are composite fire extinguishing materials containing fire extinguishing agents.

There is a known composition for an extinguishing coating comprising microencapsulated 1,2-dibromotetrafluoroethane (R-114B2 refrigerant) with a cured gelatin shell in a binder containing an epoxy resin, epoxidized polyoxychloropropylene glycerol ether, and polyethylene polyamine [4].

An extinguishing composition containing microcapsules with a core of an extinguishing agent, which are halocarbons surrounded by a coating of polymeric material distributed in a polymer binder is known. At that the polymeric binder is water-soluble or water-insoluble polymers in the form of solutions or dispersions in water or organic solvents, respectively. The material of the shell is polyurea and/or polyurethane based on polyisocyanate prepolymer. The microcapsules have different sizes in the range 2.0-100.0 μm [5].

The closest structural analogue is a microencapsulated fire extinguishing agent containing microcapsules having a core of extinguishing liquid disposed within a spherical polymer shell made of a cured spatially crosslinked polymeric material and containing mineral filler nanoparticles in the form of plates having a thickness of 1-5 nm, and the specified agent has the capability of explosion-like destruction in the temperature range of 90-230° C. The microcapsules can have an outer diameter in the range of 50-400μm and a core of an extinguishing liquid, by weight of 75-95% of the weight of the microcapsule's weight, which is a bromine-containing or fluorobrom-containing extinguishing liquid, perfluoroethyl perfluoroisopropyl ketone and/or dibromomethane or a mixture of fire extinguishing liquids selected from the group consisting of: perfluoroethyl perfluoroisopropyl ketone, dibromomethane, bromo-substituted hydrocarbons, fluorobromosubstituted hydrocarbons in the liquid state. The spherical polymeric shell can be made, for example, of a complex of polyvinyl ethanol and urea-resorcinol-formaldehyde resin or crosslinked gelatin, and may contain a mineral filler in an amount of 1-5% by weight of the shell, in the form of nano-sized plates of natural montmorillonite aluminosilicate or analogues thereof in an exfoliated state. The specified microcapsules can be used for fire extinguishing purposes in the composition of fire extinguishing composite structural material [6].

Thus, all the described fire extinguishing means are designed to eliminate the fire that has already arisen, and not to prevent it, which is the most effective way to fight fire.

The use of composite materials containing odorants for the detection of electrical faults is described in the Japanese patent application [7]. The disadvantage of the proposed composition is the use of hot melt polymers. When the heat-generating part is heated above the softening or melting temperature of the hot-melt polymer, it may be detached or drained to a part of the electrical equipment, for example, to the insulation of the wiring, the violation of which can lead to a short circuit. In addition, the description of the patent document [7] indicates that the odorant emission from the proposed polymer compositions occurs due to the melting of the material. This circumstance can be accompanied by unfavorable consequences for the electrical equipment, such as foaming and spraying of the polymeric mass with the evolved gas. Insertion of hot foamed mass, polymer droplets or polymer melt flowing off the sticker to the adjacent contacts, electrical equipment, blowers, sensors, can lead to malfunction or even ignition. In addition, for the registration of pre-fire situations one of the most significant criteria is the response speed of the system as a whole. For these purposes, the gas shall be released in a significant amount when the critical temperature is reached and quickly distributed in volume. This is possible only in the case of opening the material with a large excess pressure of gas inside the capsule (pores). In this case, the gas almost instantly leaves the material, is not occluded on it and reaches the sensor in the minimum time. Pore opening resulting from the melting of the polymer may be accompanied by the transition of the odorant to a hot melt composition (eg, dissolution) or to create a foam layer. In this case, the evaporation of gas from the surface will proceed slowly and will not lead to a one-time transition of the main amount of gas enclosed in the product into the gas phase.

The material described in the mentioned patent document JP 6-66648 [7] is considered by the authors to be the closest analogue of the present invention known from the prior art (prototype).

### DESCRIPTION OF THE INVENTION

The goal of the present invention is to create a polymeric composite material stable and safe in use, applied for early detection of pre-fire situations that arise as a result of local overheating of electrical equipment, when the heating of wires or electrical contacts exceeds the permissible operating parameters (>100° C.), but does not yet reach the level at which the thermal destruction of materials occurs, capable of ignition (>250° C.).

This objective is achieved by using a polymer composite material to form a signal about local overheating of electrical equipment, the continuous phase of which is formed by a thermosetting polymer filled with an odorant, which is sulfur dioxide, low-molecular-weight mercaptans, dialkyl sulfides, dialkyl disulfides or mixtures thereof, having an explosive destruction temperature in the range of 80-200° C.

The technical result of the claimed solution is to increase the probability of detecting a pre-fire situation at an early stage.

### BRIEF DESCRIPTION OF THE DRAWINGS

FIG. 1 shows the results of a thermogravimetric analysis of the microencapsulated composite material according to the invention prepared according to Example 1.

FIG. 2 shows the results of a thermogravimetric analysis of the microencapsulated composite material according to the invention prepared according to Example 2.

FIG. 3 shows the results of a thermogravimetric analysis of the microencapsulated composite material according to the invention prepared according to Example 3.

FIG. 4 shows the results of a thermogravimetric analysis of the microencapsulated composite material according to the invention prepared according to Example 4.

### DETAILED DESCRIPTION OF THE INVENTION

The present invention relates to the polymeric composite material filled with an odorant, which is sulfur dioxide, low-molecular-weight mercaptans, dialkyl sulfides, dialkyl disulfides or mixtures thereof, having an explosive destruction temperature in the range of 80-200° C., used to detect early pre-fire situations arising from local overheating of electrical equipment.

A distinctive feature of the polymeric composite material is the use of thermosetting polymers as polymeric materials. The use of thermosetting polymers can eliminate a number of disadvantages inherent in the prototype. Thermosetting polymers lose their integrity when heated, but they do not pass into a thermoplastic state, which excludes foaming of the material, detachment from the substrate, or flowing to current-conducting parts.

In addition, the opening of the proposed composite material based on a thermosetting polymer is not due to melting of the shell, but due to its rupture by high pressure of the superheated light-boiling substance. Since the destruction of the shell is explosive, the gas yield is significant regardless of the rate of heating. Thus, unlike the prototype, the proposed material makes it possible to record overheating of electrical equipment, even at ventilated objects and in large electric boards.

Another advantage of the crosslinked polymers is that the opening of pores in the proposed thermosetting polymers occurs not in a narrow temperature range, corresponding to the melting of the polymer (transition into a viscous state), but in a wide range. In crosslinked polymers, the opening (explosive destruction) of the shell occurs when the gas within the pore reaches the pressure of the corresponding shell strength. Because of the specific features of such polymers synthesis, the pores differ from each other both in size and thickness of the shell, and their opening occurs at different pressures and temperatures.

The latter circumstance causes one more important difference of the proposed invention. Since the opening of the polymer occurs over a wide range of temperatures and the destruction of a part of the pores at a lower opening temperature does not disrupt the integrity of other pores, having higher opening temperature, the offered material can respond repeatedly. In other words, if the proposed polymeric composite material is heated to the opening temperature in a predetermined range of opening temperatures, then cooled to a temperature lower than the specified opening temperature range, for example to a temperature corresponding to the permissible performance parameters of the equipment, and then reheated to the opening temperature in a predetermined a range of opening temperatures higher than the previous opening temperature, then upon repeated heating, there will also be sufficient gas release and system response to form the signal.

As fillers for the composite material, the present invention uses substances with a sharp, unpleasant odor. The human sense of smell is highly sensitive to such smells, so that a person usually reacts very quickly to the appearance of such substances in the atmosphere, even in fairly low concentrations. This makes it possible to detect malfunctions in the isolation of even relatively small amounts of these odorants, i.e. already at an early stage of overheating.

Odorants used in the present invention include, but are not limited to, sulfur dioxide, methyl mercaptan, ethyl mercaptan, n-propyl mercaptan, isopropyl mercaptan, n-butyl mercaptan, sec-butyl mercaptan, isobutyl mercaptan, tert-butyl mercaptan, amyl mercaptan, isoamyl mercaptan, hexyl mercaptan, dimethyl sulfide, diethylsulfide, diallyldisulfide, allyl methyl sulfide, methylethylsulfide, diisopropyl sulfide, dimethyl disulfide, diethyl disulfide, dipropyl disulfide, diisopropyl disulfide, or mixtures thereof.

Particularly preferred examples of odorants are methyl mercaptan, ethyl mercaptan, isopropyl mercaptan, isobutyl mercaptan, tert-butyl mercaptan, dimethyl sulfide, diethyl sulfide, methylethylsulfide, dimethyl disulfide, diethyl disulfide.

In some embodiments, the odorants are used in a mixture with solvents. The use of solvents allows achieving lower temperatures and narrower temperature ranges of the opening of the composite material while maintaining its mechanical characteristics.

Odorant solvents include, but are not limited to, hydrofluorochlorocarbons, hydrofluorocarbons, fluorocarbons, chlorocarbons, chlorofluorocarbons, perfluoro (ethylisopropyl ketone), alkanes, ethers, or mixtures thereof.

The use of fluorine-containing compounds as an odorant makes it possible to expand the scope of use of the proposed material due to the possibility of using an automatic gas sensor. A distinctive feature of fluorine-containing compounds is the capability to determine their presence in concentrations of about 0.001 ppm [8]. In addition, these compounds are absent in the air during normal operation of electrical equipment, which reduces the likelihood of false responses.

When using a mixture of odorant and solvents, the content of odorant in such a mixture may be 1-99%.

In some embodiments, the polymeric composite material of the invention is microcapsules with an odorant core surrounded by the shell of thermosetting polymeric material distributed in a cross-linked polymeric binder. The average outer diameter of the microcapsules is preferably in the range of 1-5000 μm, more preferably in the range of 10-500 μm, most preferably in the range of 5-50 μm. The average thickness of the polymeric shell is preferably 0.01 to 1 μm, more preferably 0.01 to 0.1 μm, most preferably 0.01 to 0.05 μm.

The polymeric binder of the present invention includes, but is not limited to, acrylic resin, epoxy resin, polyamide, polyvinyl acetate, polyester, polyurea, polyvinyl ethanol, polyurethane.

The microcapsule shell should have sufficient strength and be insoluble in the carrying fluid used to prepare the microcapsules, as well as in the material forming the core of the microcapsule.

The microcapsule shell, consisting of a thermosetting polymeric material, is preferably made of an organic polymer. Polyurethane resins, polyamide resins, polyester resins, polycarbonate resins, melamine resins, gelatin or its derivatives, polyvinyl ethanol are offered as organic polymer.

In preferred embodiments of the invention, the microcapsule shell consists of gelatin or a derivative thereof.

In the most preferred embodiments of the invention, the polymeric composite material comprises microcapsules characterized by the presence of a two-layer polymeric shell having an inner layer consisting of gelatin or a derivative thereof and an external reinforcing layer consisting of carbamide resins, resorcinol resins, melamine resins, phenolic resins or polyvinyl acetate resins.

A method of manufacturing a polymeric composite material comprising microcapsules characterized by the presence of a two-layer polymeric shell having an inner layer composed of gelatin or a derivative thereof and an external reinforcing layer consisting of urea resins, resorcinol resins, melamine resins, phenolic resins or polyvinyl acetate resins include the following stages:
a) The main coat layer of gelatin or its derivative is formed by the coacervation method. The odorant solution in freon is emulsified in an aqueous solution of gelatin or its derivative at a temperature of 35-45 □C. The emulsification time is preferably from 2 to 30 minutes, more preferably from 5 to 10 minutes. A phase-separation promoter (for example, a 5% aqueous solution of sodium phosphate) and an acid (for example a 10% aqueous solution of sulfuric acid) are added to the resulting emulsion until a pH of 4.0-5.0 is achieved. After this, the mixture is gradually cooled to 25-35 □C for 1-1.5 hours. In the process, an adsorbed gelatin layer is formed around the droplets of the odorant. The mixture is further cooled to 5-15 □C and kept at this temperature for at least one more hour.
   As the phase separation promoter, aqueous solutions of alkali metal phosphates or sulfates, gum arabic, sodium carboxymethylcellulose, polyacrylic acid, sodium alginate can be used.
   As acid, aqueous solutions of sulfuric, hydrochloric, phosphoric acids can be used. The most preferred acid is sulfuric acid.
   Before forming the reinforcing layer, it is desirable to strengthen the gelatin shell by adding a crosslinking agent. This can be done, for example, by adding 25% glutaric aldehyde solution to the resulting emulsion and maintaining the mixture at 5-15 □C for 1-1.5 hours. In addition to glutaric aldehyde, other known crosslinking agents and crosslinking methods can be used.
b) A precursor for forming the reinforcing layer is obtained by mixing urea, resorcinol, melamine, phenol or polyvinyl alcohol at room temperature with 1-4 equivalents of formaldehyde, after which the mixture is heated to 70 □C for 2.5 hours. The resulting precursor is added to the emulsion obtained in step a) at a temperature of 20-30 □C. The temperature is raised to 30-35 □□C, the pH is adjusted to 1-3.5, the resulting mixture is kept under these conditions for at least 30 minutes.
c) The microcapsules are washed, separated from the aqueous phase by decantation, dried and used to make the composite material by adding a binder.

The polymeric composite material obtained by the above described method contains microcapsules consisting of a two-layer polymer shell and a liquid core containing odorants or their solutions. The average value of the outer diameter of the microcapsules is 20-80 μm. The content of odorant is 10-90% of the mass of the material. The explosive destruction temperature of the polymeric composite material is in the range of 80-200° C., depending on the nature of the liquid in the core of the microcapsules.

In other embodiments of the invention, the polymeric composite material of the invention is a polymer gel formed by crosslinked polymer particles swollen in an odorant solution placed in a thermosetting polymeric matrix. The average particle size of the crosslinked polymer is preferably 50-500 μm, more preferably 50-200 μm.

The crosslinked polymer of the present invention includes, but is not limited to, polyacrylamide, crosslinked N, N′-methylenebisacrylamide, polyvinyl ethanol crosslinked with epichlorohydrin, and polyvinyl ethanol crosslinked with glutaric aldehyde.

In preferred embodiments of the invention, the crosslinked polymer is a polyvinyl ethanol crosslinked with epichlorohydrin.

The polymeric matrix included in the composite material includes, but is not limited to, polyorganosiloxanes, polyvinyl acetate, epoxy resins.

A method of preparing a polymeric composite material comprising a polymer gel formed by crosslinked polymer particles swollen in an odorant solution placed in a polymeric matrix includes the following stages:
a) An aqueous solution of NaOH is added to the aqueous solution of polyvinyl ethanol with vigorous stirring for 30 minutes at 95 □C. Epichlorohydrin is added to the resulting mixture at 70 □C and stirred until gelation begins. The stirring is then stopped and the mixture is maintained at 70 □C for 3 hours. The gel block is grained, washed with water, ethanol, acetone and dried under vacuum at 60 □C. The dried polymer is grained in a mill and fractionated, taking a fraction of 50-100 μm.
b) The cross-linked polymer particles are placed in an alcoholic odorant solution and allowed to stand for 4 days at room temperature.
c) The swollen particles of the crosslinked polymer are separated from the solution by decantation.
d) Polyethylene polyamine is added to the swollen gel suspension, the mixture is vigorously stirred for 10 minutes, after which an epoxy resin is added thereto. The resulting mass is intensively mixed, poured into molds and left for 36 hours. The resulting material is vacuum-processed for 3 hours at a temperature of 60 □C and a pressure of 1 mm Hg.

The polymeric composite material obtained by the above described method comprises particles of polyvinyl ethanol crosslinked with epichlorohydrin swollen in an odorant solution. The average size of the swollen particles of the crosslinked polymer is 80-150 μm. The content of odorant is 10-70% of the mass of the material. The explosive destruction temperature of the polymeric composite is in the range of 70-160° C.

In other embodiments of the invention, the polymeric composite material is a sorbent particle with an odorant occluded thereon, placed in a thermosetting polymeric matrix. The average particle size is preferably 10-2000 μm.

The sorbent includes, but is not limited to this list, silica gel, alumina, aluminosilicates, activated carbon.

The polymeric matrix included in the composite material includes, but is not limited to, polyurethane, polyurea.

A method of preparing a polymeric composite material comprising sorbent particles with an odorant occluded thereon, placed in a polymeric matrix, comprises the following stages:
a) Colloidal silicon dioxide is mixed with the odorant solution in 1,2-dibromotetrafluoroethane (R-114B2 refrigerant) and left overnight with vigorous stirring.
b) The precipitate is decanted, excess liquid is allowed to drain.
c) 4,4′-diphenylmethane diisocyanate is added to the resulting suspension. Large inclusions are separated, the residue is thoroughly mixed and polyethylene polyamine is added thereto. After obtaining a homogeneous mass, the product is distributed into the molds and allowed to stand for 3 days until the finished product is obtained.

The composite material obtained by the above described method contains silica gel particles with an odorant adsorbed thereto. The average particle size is 50-200 μm. The content of odorant is 10-50% of the mass of the material. The explosive destruction temperature of the polymeric composite is in the range of 80-150° C.

In other embodiments of the invention, the polymeric composite material is a porous cross-linked polymer particles with closed-type pores or channels filled with an odorant or odorant solution placed in a thermosetting polymeric matrix. The average particle size is preferably 200-5000 μm. The average pore diameter is preferably 10-100 μm.

As a porous polymer, polystyrene, polyorganosiloxanes, polyurethane, polyurea are offered.

The polymeric matrix included in the composite material includes, but is not limited to, polyvinyl acetate, epoxy resins, silicone.

A method of preparing the polymeric composite material comprising porous polymer particles with closed-type pores or channels filled with an odorant or an odorant solution placed in a polymeric matrix includes the following stages:
a) Toluene diisocyanate is added to the odorant solution in R-114B2 refrigerant, the resulting mixture is emulsified in an aqueous solution of polyvinyl alcohol until a homogeneous emulsion is obtained.
b) The solution of polyethylene polyamine (PEPA) in water is added and the resulting solution is allowed to stand within 24 hours.
c) The lower layer is separated, silicone is added to it, the curing catalyst and mixed until a uniform mass is formed.
d) The product is transferred to ready-made molds and allowed to stand for 1 day.

The polymeric composite material obtained by the above described method comprises particles of polyvinyl ethanol with closed-type pores filled with an odorant solution placed in a polymeric matrix. The average particle size of the porous polymer is 500-3000 μm. The average pore diameter is 20-100 μm. The content of odorant is 20-80% of the mass of the material. The explosive destruction temperature of the polymeric composite material is in the range of 90-180° C.

When a certain temperature is reached, the filler boils up, which leads to the opening of the composite material and the release of gaseous products into the atmosphere, where their presence can be detected by smelling and will be a signal of the electrical equipment malfunction. The change in the composition of the filler and the polymeric matrix makes it possible to vary the temperature of the opening of the material.

Since the gaseous substances released by heating the composite material are not present under normal conditions in the atmosphere, and also because they are released at relatively low temperatures (before the thermal decomposition of the materials from which wires and wiring devices are made), the invention composition material allows to detect potentially fire hazardous situations long before the appearance of smoke or open fire.

Thus, the polymeric composite material of the invention makes it possible to detect pre-fire situations much earlier than the existing analogues. Due to the use of thermosetting polymers and direct contact of the material with the heating section of the electrical circuit, a high rate of appearance of the overheating signal is ensured.

The study of the opening capability of the polymeric composite material was carried out by thermogravimetric method. The sample was heated from the room temperature to a temperature of 300° C. at a rate of 10° C. per minute, while the mass of the sample was measured.

In the following examples, all percentages are given by weight, unless otherwise indicated. It should be understood that these examples, while demonstrating the preferred embodiments of the present invention, are given for illustrative purposes only and are not to be construed as limiting the scope of the claimed invention.

### EXAMPLE 1

Gelatine in an amount of 10 grams is mixed with 190 g of distilled water. The resulting mixture is allowed to stand at the room temperature for 20 minutes, then heated at 50° C. for 30 minutes. 150 g of a 30% solution of diethyl sulfide in 1,2-dibromotetrafluoroethane are added to the resulting 5% aqueous gelatin solution at 40° C. and stirred for 3-5 minutes to obtain an emulsion.

Then 20 g of a 5% aqueous solution of sodium phosphate are added, the pH is adjusted to 4.8-5.0 with a 10% solution of sulfuric acid, and the mixture is gradually cooled to 32-33° C. for 1.5 hours.

After that, the mixture is cooled to 8-12° C. and allowed to stand for 1 hour at this temperature. In the process a gelatin film is formed around the drops of the odorant solution.

5 ml of a 25% aqueous solution of glutaric aldehyde are added to the resulting emulsion, after which it is allowed to stand for 1 hour at 8-12° C. The mixture is then gradually heated to 20-25° C., aged for 3 hours and left to cure the crosslinked gelatin shell.

To 85 g of distilled water, resorcin is added in an amount of 15 g, 25 ml of a 37% aqueous solution of formaldehyde and the mixture is stirred for 60 minutes at room temperature to obtain a precursor of resorcinol resin. The precursor solution is then added to the solution containing the cured gelatin capsules, the pH is adjusted to 1.3-1.7 with a 10% solution of sulfuric acid, and the mixture is stirred for 3 hours at 30° C.

After stopping the stirring, the microcapsules settle out. The supernatant is separated, the microcapsules are washed three times by decantation. 10 g of polyvinyl ethanol are added to the resulting concentrated suspension and mixed thoroughly.

After applying the mixture to the substrate with a layer of 5 mm and completely drying, the required composite material is obtained.

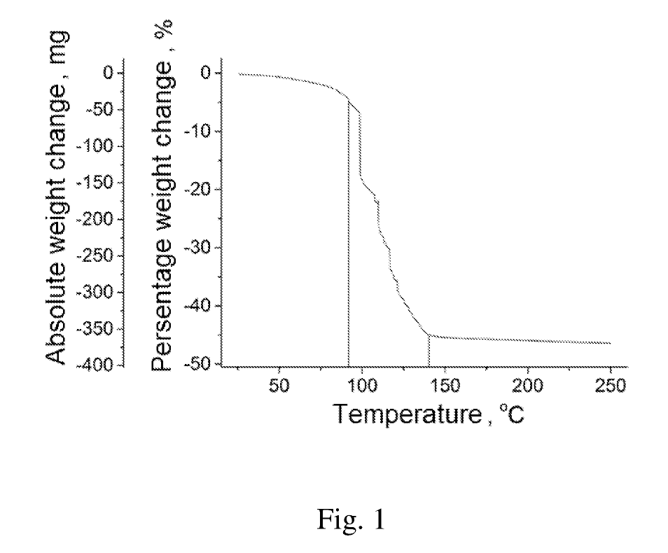

The results of thermogravimetric analysis of the obtained composite material are given in FIG. 1. The explosive destruction temperature of the sample was 92-141° C.

### EXAMPLE 2

A solution of 5 g of sodium hydroxide in 10 ml of water is added to a solution of 10 g of polyvinyl alcohol with a number average molecular weight of 20,000 in 30 ml of water at 95° C. with vigorous stirring for 10 minutes. The temperature is lowered to 70° C. and 10 ml of epichlorohydrin is added, mixed until gel formation, after which the stirrer is stopped and the temperature is maintained at 70° C. for 3 hours. The gel block is grained, washed with water, ethanol, acetone and dried under vacuum at 60° C. The dried polymer is grained in a mill and fractionated, taking a fraction of 50-100 μm.

The cross-linked polymer particles are placed in a solution of dimethyl sulfide in ethanol and allowed to stand for 4 days at room temperature.

The swollen particles of the crosslinked polymer are separated from the solution by decantation. After that, the particles are mixed with a 30% solution of polyvinyl acetate in ethanol, the resulting mixture is dried at room temperature.

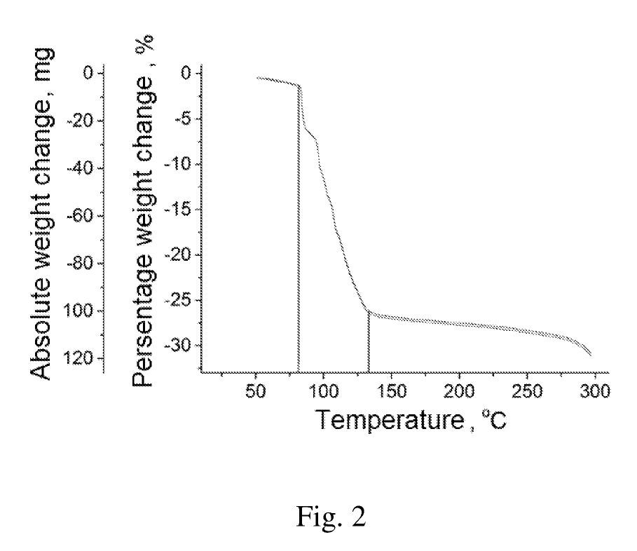

The results of thermogravimetric analysis of the obtained composite material are given in FIG. 2. The explosive destruction temperature of the sample was 79-132° C.

### EXAMPLE 3

Aerosil (fraction 50-200 μm) in an amount of 10 grams is mixed with 150 g of a 40% solution of ethyl mercaptan in R-114B2 halon and left for a day being intensively stirred. The sediment is decanted, excess liquid is drained and 180 g of 4,4′-diphenylmethane diisocyanate are added. Large inclusions are separated, the residue is thoroughly mixed and 15 g of polyethylene polyamine are introduced within 5 minutes. After obtaining a homogeneous mass, the product is distributed into the molds and allowed to stand for 3 days until the finished product is obtained.

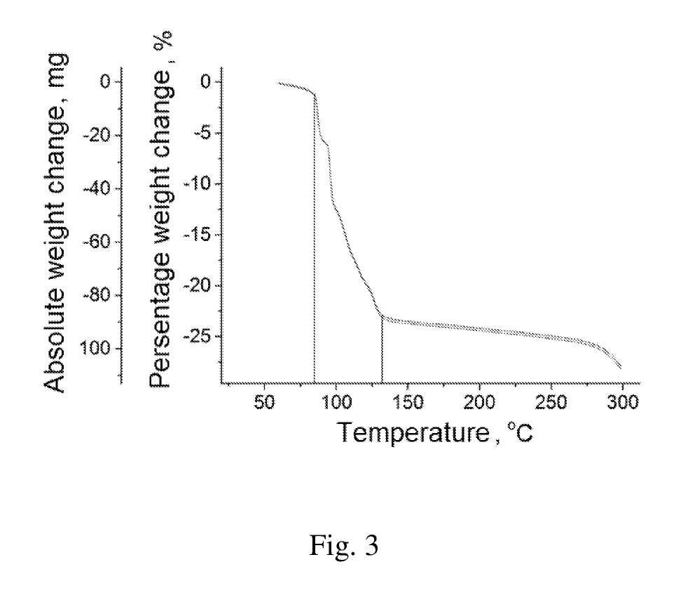

The results of thermogravimetric analysis of the obtained composite material are given in FIG. 3. The explosive destruction temperature of the sample was 86-132° C.

### EXAMPLE 4

7 g of toluene diisocyanate are added to 200 g of a 40% solution of diethyl sulfide in R-114B2 halon, after which the mixture is emulsified in 100 g of an aqueous solution of polyvinyl ethanol at a concentration of 1.2 g/l until a uniform emulsion is obtained. 100 ml of PEPA solution in water at a concentration of 100 g/l are added and the resulting solution is allowed to stand for 24 hours. The lower layer is left to stand, separated, and 250 g of silicone (synthetic thermoresistant low-molecular SCTN rubber resin, grade A), 10 g of cold curing catalyst No. 68 are added and mixed until a homogeneous mass is formed. The product is transferred to ready-made molds and allowed to stand for 1 day.

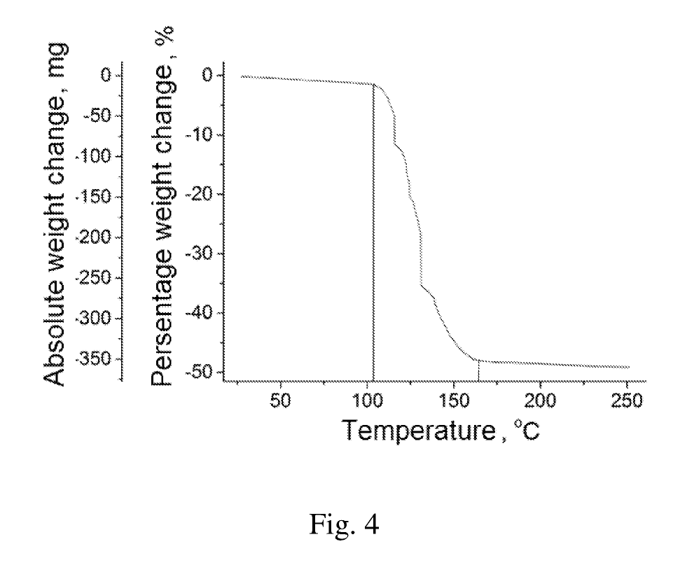

The results of thermogravimetric analysis of the obtained composite material are given in FIG. 4. The explosive destruction temperature of the sample was 103-163° C.

Information Sources:

1. Author's certificate of the U.S. Ser. No. 1,277,159, IPC G08B17/10, 1985.

2. Patent of the Russian Federation No. 2022250, IPC G01N21/61, 1994.

3. Patent of the U.S. Pat. No. 5,654,684, IPC G08B25/08, G08B25/10, 1997

4. Author's certificate of the U.S. Ser. No. 1,696,446, IPC C09D163/00, C09K21/08, 1982.

5. Patent of the Russian Federation 2403934, IPC A62D1/00, 2010.

6. Patent of the Russian Federation 2469761, IPC A62D1/00, B82B3/00, 2012

7. Patent document JP 6-66648, 1994.

8. A. P. Dolin, A. I. Karapuzikov, Yu. A. Kovalkova, “Efficiency of using a laser leak detector “KARAT” to determine the location and level of development of electrical equipment malfunction”, Electro, No 6. PP. 25-28 (2009).

1. A polymeric composite material comprising a continuous phase including a thermosetting polymer and an odorant encapsulated in specified continuous phase, which is selected from sulfur dioxide, low-molecular-weight mercaptans, dialkyl sulfides, dialkyl disulfides or mixtures thereof, having an explosive destruction temperature in the range of 80-200° C., to generate a signal about local overheating of electrical equipment.

2. The polymeric composite material according to claim 1, differing by the fact that gas emission occurs multiple times in repeated heating cycles to a temperature in the explosive destruction temperature range and subsequent cooling to lower temperatures below the explosive destruction temperature range.

3. The polymeric composite material according to claim 1, differing by the fact the the odorant is sulfur dioxide, methyl mercaptan, ethyl mercaptan, n-propyl mercaptan, isopropyl mercaptan, n-butyl mercaptan, sec-butyl mercaptan, isobutyl mercaptan, tert-butyl mercaptan, amyl mercaptan, isoamyl mercaptan, hexyl mercaptan, dimethyl sulfide, diethyl sulfide, diallyldisulfide, allyl methyl sulfide, methylethylsulfide, diisopropyl sulfide, dimethyl disulphide, diethyl disulfide, dipropyl disulfide, diisopropyl disulfide, or any mixture thereof.

4. The polymeric composite material according to claim 3, differing by the fact that odorant additionally comprises a solvent selected from the grow p consisting of hydrofluorochlorocarbons, hydrofluorocarbons, fluorocarbons, chlorocarbons, chlorofluorocarbons, perfluoro (ethylisopropyl ketone), alkanes, ethers and mixtures thereof.

5. The polymeric composite material according to claim 1, differing by the fact that the material comprises microcapsules with an odorant core surrounded by a shell from the thermosetting polymeric material distributed in a polymeric binder.

6. The polymeric composite material according to claim 5, differing by the fact that the polymeric binder is an acrylic resin and/or epoxy resin and/or polyamide and/or polyvinyl acetate and/or polyester and/or polyurea and/or polyvinyl ethanol, and/or polyurethane.

7. The polymeric composite material according to claim 5, differing by the fact that the microcapsules are characterized by the presence of a two-layer polymeric shell having an inner layer consisting of gelatin or a derivative thereof and an external reinforcing layer consisting of urea resins, resorcinol resins, melamine resins, phenolic resins or polyvinyl acetate resins.

8. The polymeric composite material according to claim 1, differing by the fact that material comprises particles of a crosslinked polymer swollen in a solution of an odorant enclosed in a polymeric matrix.

9. The polymeric composite material according to claim 8, differing by the fact that the cross-linked polymer is a polyacrylamide crosslinked with N, N′-methylenebisacrylamide, polyvinyl alcohol crosslinked with epichlorohydrin or polyvinyl ethanol crosslinked with glutaraldehyde.

10. The polymeric composite material according to claim 8, differing by the fact that the polymeric matrix is a polyorganosiloxane, a polyvinyl acetate, an epoxy resin.

11. The polymeric composite material according to claim 1, differing by the fact that the material comprises sorbent particles, with an odorant occluded thereon, enclosed in a polymeric matrix.

12. The polymeric composite material according to claim 11, differing by the fact that the sorbent is silica gel, alumina, aluminosilicates or activated carbon.

13. The polymeric composite material according to claim 11, differing by the fact that the polymeric matrix is a polyurethane or polyurea.

14. The polymeric composite material according to claim 1, differing by the fact that the material comprises porous polymer particles with closed-type pores or channels filled with an odorant or odorant solution enclosed in a polymeric matrix.

15. The polymeric composite material according to claim 14, differing by the fact that the polymeric matrix is polyvinyl acetate, epoxy resin, silicone.

16-26. (canceled)
